(19) United States
(12) Patent Application Publication
(10) Pub. No.: US 2017/0064052 A1
(43) Pub. Date: Mar. 2, 2017

(54) COMMUNICATION DEVICE

(71) Applicant: Acer Incorporated, New Taipei City (TW)

(72) Inventors: Kun-Sheng Chang, New Taipei City (TW); Shih-Ting Huang, New Taipei City (TW); Ching-Chi Lin, New Taipei City (TW)

(21) Appl. No.: 14/951,511

(22) Filed: Nov. 25, 2015

(30) Foreign Application Priority Data
Aug. 26, 2015 (TW) 104127828

(51) Int. Cl. H04M 1/02; H04B 1/3827

(52) U.S. Cl. CPC H04M 1/026; H04B 1/3827

(57) ABSTRACT

A communication device including a ground plane and an antenna element is provided. The antenna element includes a feeding portion, a first radiation portion, a second radiation portion and an adjusting portion. The first radiation portion and the feeding portion form a first resonant path, and the first radiation portion includes a first portion and a second portion. The first portion faces a first edge of the ground plane and the second portion, and the second portion extends from a second edge of the ground plane. The second radiation portion and the feeding portion form a second resonant path. The antenna element operates in a first band and a second band through the first resonant path and the second resonant path. The adjusting portion and part of the first radiation portion form a current-dividing path to adjust impedance of the antenna element operating in the second band.

### CROSS-REFERENCE TO RELATED APPLICATION

This application claims the priority benefit of Taiwan application serial no. 104127828, filed on Aug. 26, 2015. The entirety of the above-mentioned patent application is hereby incorporated by reference herein and made a part of this specification.

### BACKGROUND OF THE INVENTION

Field of the Invention

The invention relates to a communication device, and more particularly to a communication device having a low-profile antenna element.

Description of Related Art

Recently, in addition to functional demands, communication devices also develop toward slimmer, smaller and light-weight designs. For instance, current communication devices adopt narrow-frame designs, so as to attract the attention of consumers. However, after incorporating the narrow-frame designs, there is less space in communication devices for antenna elements. In particular, in narrow-frame designs, the height of the antenna element in the Y-axis direction is considerably limited. Therefore, it has been an important issue to design low-profile antenna elements.

### SUMMARY OF THE INVENTION

A communication device is provided, which reduces space occupied by a first radiation portion and a second radiation portion in the Y-axis direction so that an antenna element has a low-profile characteristic.

The communication device of the invention includes a ground plane and an antenna element. The ground plane includes a first edge and a second edge that are adjacent to each other. The antenna element includes a feeding portion, a first radiation portion, a second radiation portion and an adjusting portion. The feeding portion is close to the first edge of the ground plane. The first radiation portion and the feeding portion form a first resonant path, and the first radiation portion includes a first portion and a second portion that are electrically connected. The first portion faces the first edge and the second portion, and the second portion extends from the second edge. The second radiation portion and the feeding portion form a second resonant path. The antenna element operates in a first band and a second band through the first resonant path and the second resonant path. The adjusting portion is electrically connected between the first portion and the second portion. In addition, the adjusting portion and part of the first radiation portion form a current-dividing path to adjust impedance of the antenna element operating in the second band.

In view of the above, the first portion of the first radiation portion of the invention faces the first edge of the ground plane and the second portion and uses the current-dividing path to adjust the impedance of the antenna element operating in the second band. Thereby, the space occupied by the first radiation portion and the second radiation portion in the Y-axis direction is reduced, so that the antenna element has the low-profile characteristic.

To make the above features and advantages of the present invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the invention.

FIG. 1 is a schematic diagram of a communication device according to an embodiment of the invention.

FIGS. 2 and 3 are respectively schematic diagrams for illustrating operation of the antenna element according to an embodiment of the invention.

FIGS. 4 and 5 are respectively schematic diagrams of the appearance of a communication device according to an embodiment of the invention.

FIG. 6 is a diagram of return loss of an antenna element in a notebook mode according to an embodiment of the invention.

FIG. 7 is a diagram of return loss of an antenna element in a tablet mode according to an embodiment of the invention.

### DESCRIPTION OF EMBODIMENTS

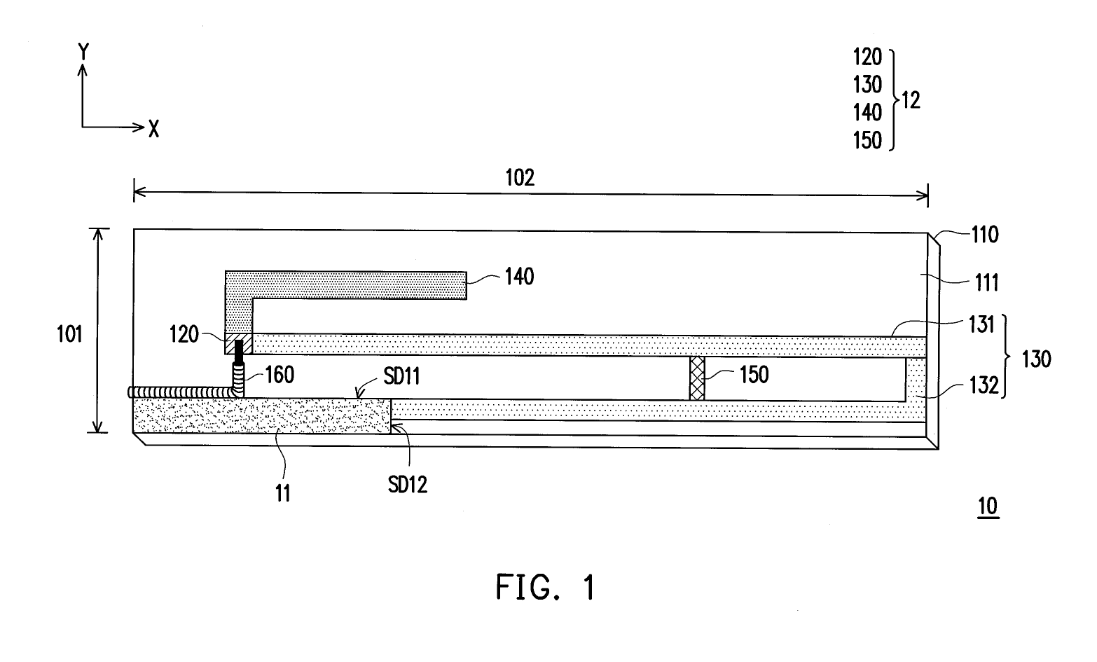

FIG. 1 is a schematic diagram of a communication device according to an embodiment of the invention. As shown in FIG. 1, a communication device 10 includes a ground plane 11, an antenna element 12 and a substrate 110. The ground plane 11 and the antenna element 12 are disposed on a surface 111 of the substrate 110, and the substrate 110 may be, for example, a printed circuit board. In other words, the antenna element 12 may be, for example, a planar antenna, and the antenna element 12 includes a feeding portion 120, a first radiation portion 130, a second radiation portion 140 and an adjusting portion 150.

The ground plane 11 includes a first edge SD11 and a second edge SD12 that are adjacent to each other. The feeding portion 120 is close to the first edge SD11 of the ground plane 11. The first radiation portion includes a first portion 131 and a second portion 132. A first end of the first portion 131 is electrically connected to the feeding portion 120. A first end of the second portion 132 is electrically connected to a second end of the first portion 131, and a second end of the second portion 132 is electrically connected to the second edge SD12 of the ground plane 11. The shape of the first portion 131 may be, for example, linear, and the shape of the second portion 132 may be, for example, inverted-L. Furthermore, the first portion 131 faces the second portion 132 and the first edge SD11 of the ground plane 11. The second portion 132 extends from the second edge SD12 of the ground plane 11. Thereby, the shape of the first radiation portion 130 is like an inverted U and has an opening towards a first direction (for example, −X-axis direction).

A first end of the second radiation portion 140 is electrically connected to the feeding portion 120, and a second end of the second radiation portion 140 is an open end. In addition, the second radiation portion 140 includes a bend, so that part of the second radiation portion 140 is parallel to the first portion 131 of the first radiation portion 130. Furthermore, the shape of the second radiation portion 140 may be, for example, an inverted L, and the second radiation portion 140 and the first portion 131 may form an opening towards a second direction (for example, X-axis direction). The adjusting portion 150 is electrically connected between the first portion 131 and the second portion 132, and the adjusting portion 150 is parallel to part of the second portion 132.

In operation, the feeding portion 120 and the first radiation portion 130 form a first resonance path, and the feeding portion 120 and the second radiation portion 140 form a second resonance path. In addition, the antenna element 12 receives a feeding signal from a transceiver (not shown) in the communication device 10 through the feeding portion 120. For instance, the feeding portion 120 may be electrically connected to the transceiver through a coaxial cable 160, wherein an inner conductor of the coaxial cable 160 is electrically connected to the feeding portion 120, and an outer conductor of the coaxial cable 160 is electrically connected to the ground plane 11.

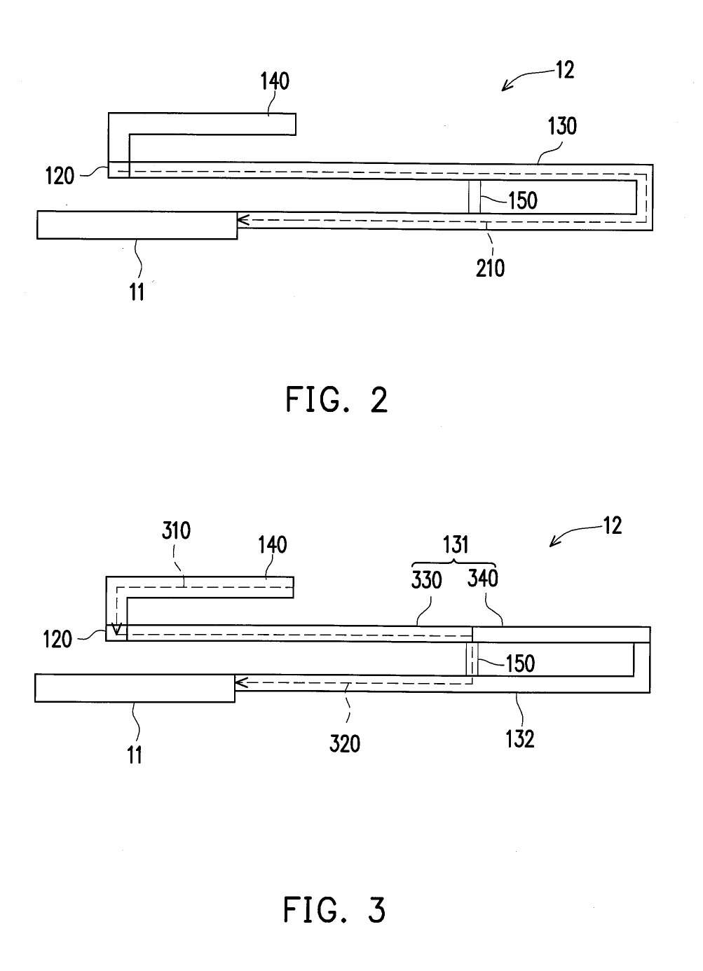

When excited by the feeding signal, the antenna element 12 generates two different resonant modes through the first resonance path and the second resonance path, so as to operate in the first band and the second band. For persons having ordinary skill in the art to understand more about the invention, FIGS. 2 and 3 are respectively schematic diagrams for illustrating operation of the antenna element according to an embodiment of the invention, and the operation of the antenna element is further described with reference to FIGS. 1 to 3.

As shown in FIG. 2, the feeding portion 120 and the first radiation portion 130 form a first resonance path 210. When excited by the feeding signal, the antenna element 12 generates the first resonant mode through the first resonance path 210, so as to operate in the first band (for example, a low-frequency band). It is worth noting that the first resonance path 210 has a loop structure. That is, the first radiation portion 130 has a loop antenna structure. In other words, the first resonance path 210 is ½ wavelength of the lowest frequency of the first band, and the antenna element 12 operating in the first band (for example, a low-frequency band) is less easily disturbed by external environments.

As shown in FIG. 3, the feeding portion 120 and the second radiation portion 140 form a second resonance path 310. When excited by the feeding signal, the antenna element 12 generates the second resonant mode through the second resonance path 310, so as to operate in the second band (for example, a high-frequency band). In addition, the second radiation portion 140 has a monopole antenna structure. That is, the second resonant path 310 is ¼ wavelength of the lowest frequency of the second band. Furthermore, part of the first portion 131 and the adjusting portion 150 and part of the second portion 132 form a current-dividing path 320. That is, the adjusting portion 150 and part of the first radiation portion 130 form the current-dividing path 320. Thereby, the adjusting portion 150 and part of the first radiation portion 130 are equivalent to an inductive element. Thus, when the antenna element 12 operates in the second band, the current-dividing path 320 has an inductive effect, and the inductive effect is used for reducing a capacitive effect between the second radiation portion 140 and the ground plane 11.

In other words, the adjusting portion 150 and part of the first radiation portion 130 is used for adjusting the impedance of the antenna element 12 operating in the second band, so that the antenna element 12 has good impedance match in the second band. In addition, the inductive effect contributed by the current-dividing path 320 may be adjusted by changing the place where the adjusting portion 150 is disposed. For instance, as shown in FIG. 3, based on the place where the adjusting portion 150 is disposed, the first portion 131 may be divided into a first segment 330 and a second segment 340. The first segment 330 is electrically connected to the feeding portion 120, and the second segment 340 is electrically connected to the second portion 132. In a preferable embodiment, the length of the first segment 330 is twice the length of the second segment 340.

It is worth mentioning that the ground plane 11 and the second portion 132 of the first radiation portion 130 are arranged in sequence along the X-axis direction, and the first portion 131 and second portion 132 of the first radiation portion 130 face each other. Thereby, the space occupied by the first radiation portion 130 in the Y-axis direction is effectively reduced, so that the height of the antenna element 12 in the Y-axis direction is reduced. In addition, since the impedance of the antenna element 12 operating in the second band may be adjusted with the current-dividing path, the antenna element 12 is still able to maintain good radiation characteristics when the second radiation portion 140 is nearby the ground plane 11. Thereby, the space occupied by the second radiation portion 140 in the Y-axis direction is effectively reduced, so that the height of the antenna element 12 in the Y-axis direction is further reduced.

For instance, the area occupied by the antenna element 12, the coaxial cable 160 and the ground plane 11 may be expressed by a height 101 and a width 102 in FIG. 1. That is, the height 101 in FIG. 1 includes a height of the antenna element 12 in the Y-axis direction. In an embodiment, the first band and the second band covered by the antenna element 12 may be, for example, 2.4 GHz and 5 GHz, and the height 101 and the width 102 may be, for example, 4.5 mm and 24 mm. It is worth noting that current antenna elements operable in 2.4 GHz and 5 GHz mostly have a height greater than 8 mm. In other words, the antenna element 12 in FIG. 1 has the low-profile characteristic. That is, the communication device 10 has a low-profile antenna element 12, so as to be feasible for narrow-frame designs.

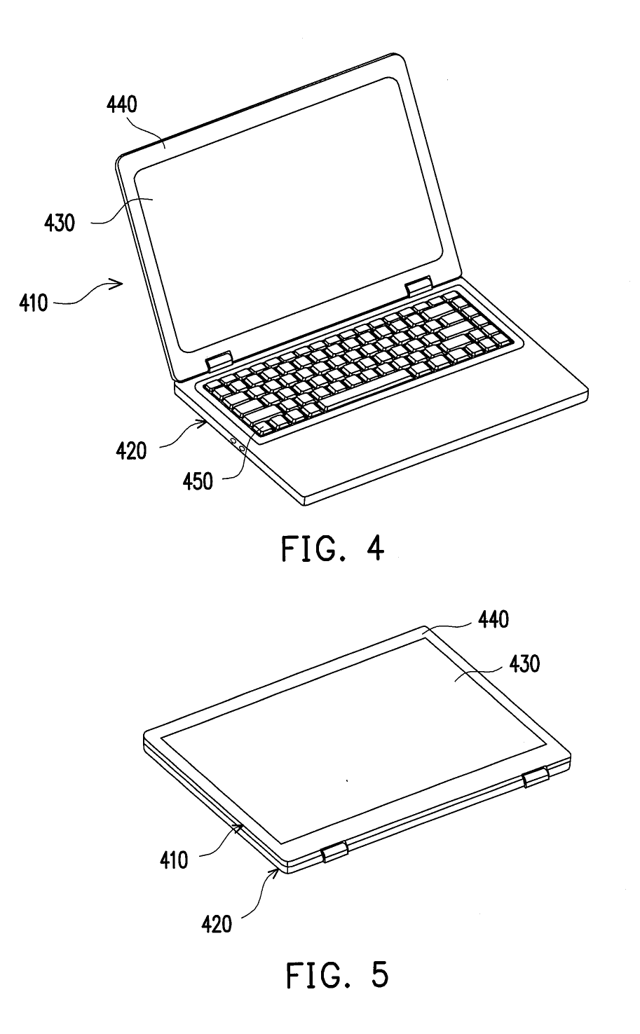

For instance, FIGS. 4 and 5 are respectively schematic diagrams of the appearance of a communication device according to an embodiment of the invention. As shown in FIGS. 4 and 5, the communication device 10 further includes a first body 410 and a second body 420, and a display 430 and a narrow frame 440 are disposed on the front surface of the first body 410, and a keyboard 450 is disposed on the front surface of the second body 420. In addition, the first body 410 may be unfolded with respect to the second body 420, so that there is an included angle between the front surface of the first body 410 and the front surface of the second body 420.

As shown in FIG. 4, when the included angle between the front surface of the first body 410 and the front surface of the second body 420 is greater than 0 but smaller than 180, the communication device 10 is in a notebook mode. On the other hand, as shown in FIG. 5, when the included angle between the front surface of the first body 410 and the front surface of the second body 420 is equal to 360, the first body 410 overlaps with the second body 420 back to back, so that the communication device 10 is in a tablet mode. Furthermore, the antenna element 12 in FIG. 1 may be disposed in the first body 410 and face the narrow frame 440 surrounding the display 430. In other words, the antenna element 12 in the communication device 10 is disposed with respect to the narrow frame 440 of the display 430. In addition, since the antenna element 12 has the low-profile characteristic, the antenna element 12 matches the design needs for the display 430 having the narrow frame 440.

It is worth noting that in the tablet mode, low-frequency operation of current antenna elements are often easily affected by external environments (for instance, metal back covers of the first body 410 and the second body 420). However, in terms of the antenna element 12 in FIG. 1, the first resonance path corresponding to the first band (for example, the low-frequency band) has the loop structure, and therefore the antenna element 12 operating in the first band (for example, the low-frequency band) is less easily disturbed by external environments. In other words, in both the notebook mode and the tablet mode, the antenna element 12 maintains good radiation characteristics, so that the communication device 10 has good communication quality.

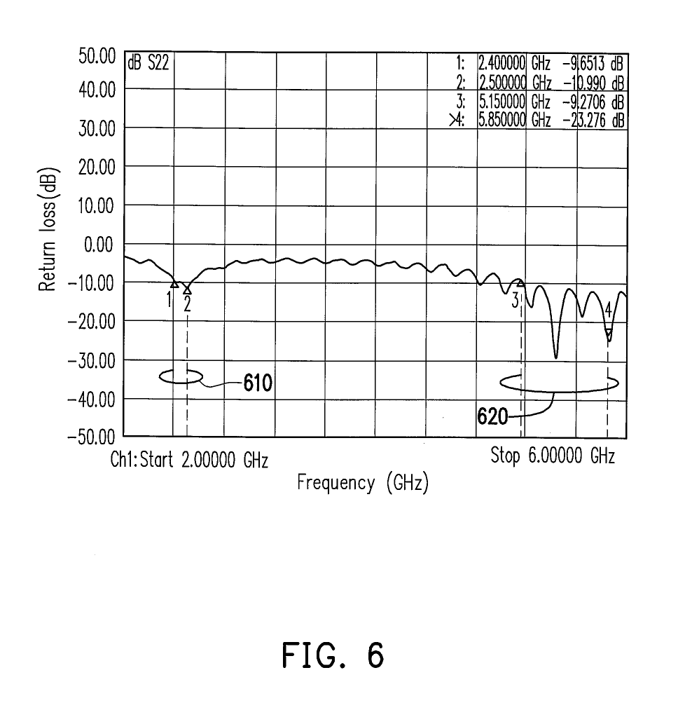

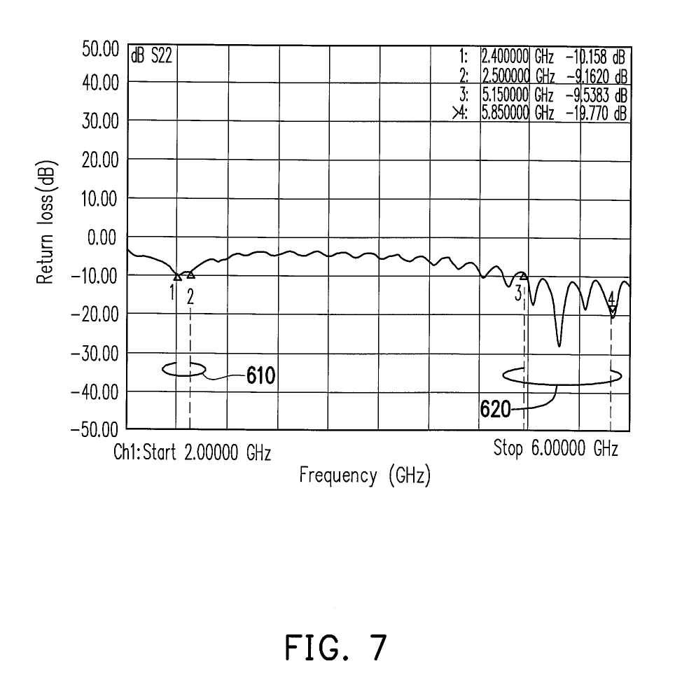

For instance, FIG. 6 is a diagram of return loss of an antenna element in the notebook mode according to an embodiment of the invention, and FIG. 7 is a diagram of return loss of an antenna element in the tablet mode according to an embodiment of the invention. As shown in FIGS. 6 and 7, the antenna element 12 is operable in a first band 610 and a second band 620. In addition, in both the notebook mode and the tablet mode, the antenna element 12 keeps return loss in the first band 610 and the second band 620 under −10 dB.

In view of the above, the first portion in the first radiation portion of the invention faces the first edge of the ground plane and the second portion, and the second portion extends from the second edge of the ground plane. Thereby, the space occupied by the first radiation portion in the Y-axis direction is reduced, so that the height of the antenna element in the Y-axis direction is reduced. In addition, the current-dividing path is used in the invention to adjust the impedance of the antenna element 12 operating in the second band, so as to reduce the space occupied by the second radiation portion in the Y-axis direction, so that the height of the antenna element in the Y-axis direction is further reduced. Thereby, the antenna element in the communication device has the low-profile characteristic, so as to be feasible for narrow-frame designs.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A communication device, comprising:
a ground plane, comprising a first edge and a second edge that are adjacent to each other; and
an antenna element, comprising:
a feeding portion, close to the first edge of the ground plane;
a first radiation portion, forming a first resonant path with the feeding portion and comprising a first portion and a second portion that are electrically connected, wherein the first portion faces the first edge and the second portion, and the second portion extends from the second edge;
a second radiation portion, forming a second resonant path with the feeding portion, wherein the antenna element operates in a first band and a second band through the first resonant path and the second resonant path; and
an adjusting portion, electrically connected between the first portion and the second portion, and the adjusting portion and part of the first radiation portion form a current-dividing path to adjust impedance of the antenna element operating in the second band.

2. The communication device as claimed in claim 1, wherein the feeding portion electrically connects a first end of the first portion and a first end of the second radiation portion, a second end of the second radiation portion is an open end, a first end of the second portion is electrically connected to a second end of the first portion, and a second end of the second portion is electrically connected to the second edge.

3. The communication device as claimed in claim 1, wherein the first portion is divided into a first segment and a second segment based on the adjusting portion, the first segment is electrically connected to the feeding portion, the second segment is electrically connected to the second portion, and the length of the first segment is twice the length of the second segment.

4. The communication device as claimed in claim 1, wherein the adjusting portion is parallel to part of the second portion.

5. The communication device as claimed in claim 4, wherein the shape of the first portion is linear, and the shape of the second portion is inverted-L.

6. The communication device as claimed in claim 5, wherein the shape of the second radiation portion is inverted-L.

7. The communication device as claimed in claim 1, wherein the first resonant path is ½ wavelength of the lowest frequency of the first band.

8. The communication device as claimed in claim 1, wherein the second resonant path is ¼ wavelength of the lowest frequency of the second band.

9. The communication device as claimed in claim 1, wherein the second radiation portion comprises a bend, so that part of the second radiation portion is parallel to the first portion.

10. The communication device as claimed in claim 1, wherein the current-dividing path has an inductive effect, so as to reduce a capacitive effect between the second radiation portion and the ground plane.
